(19) United States
(12) Patent Application Publication
(10) Pub. No.: US 2011/0050739 A1
(43) Pub. Date: Mar. 3, 2011

(54) IMAGE PROCESSOR AND IMAGE PROCESSING METHOD

(75) Inventor: Toshiyuki NAMIOKA, Saitama (JP)

(73) Assignee: KABUSHIKI KAISHA TOSHIBA, Tokyo (JP)

(21) Appl. No.: 12/751,259

(22) Filed: Mar. 31, 2010

(30) Foreign Application Priority Data
Aug. 31, 2009 (JP) 2009-200988

(51) Int. Cl. G09G 5/10

(52) U.S. Cl. 345/690

(57) ABSTRACT

According to one embodiment, an image processor includes: a luminance calculator configured to calculate a luminance of an illumination light based on an image signal, the illumination light illuminating a display screen displaying the image signal; a gradation corrector configured to correct a first gradation of the image signal to a second gradation, based on the luminance; a parameter determining module configured to determine a parameter of gradation smoothing process to be performed on an amplitude of the image signal based on the luminance; and a processing module configured to perform the gradation smoothing process on the image signal with the second gradation, by using the parameter.

### CROSS-REFERENCE TO RELATED APPLICATIONS

This application is based upon and claims the benefit of priority from Japanese Patent Application No. 2009-200988, filed on Aug. 31, 2009, the entire contents of which are incorporated herein by reference.

### BACKGROUND

1. Field

One embodiment of the invention relates to an image processor configured to process an image signal and an image processing method.

2. Description of the Related Art

Non-light-emitting display device such as a liquid crystal display (LCD) device includes an illuminator for illuminating a display screen. For example, Japanese Patent No. 3523170 discloses such LCD device, and the device controls luminance of an illumination light of the illuminator based on an input image signal. Accordingly, the luminance of the illumination light is changed, so that the dynamic range of the entire screen is expanded.

Japanese Patent Application Publication (KOKAI) No. 2008-160440 discloses gradation smoothing process performed on a region with a plain image signal.

The image signals are quantized and digitalized by a finite bit number, thereby causing quantization noise. Recent high definition digital image signals are quantized by 10 bits or 12 bits, but most of the signals are quantized by 8 bits. The noise due to the quantization may be reduced by the gradation smoothing process mentioned above. However, when the luminance of the illumination light is controlled to expand the dynamic range as disclosed in Japanese Patent No. 3523170, gain of the image signals is also caused to be changed. Therefore, the gradation smoothing in which appropriate amplitudes are taken as the quantization noise cannot be performed on the image signals, and the quantization noise cannot accurately be smoothed out.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a display apparatus according to an embodiment of the invention;

FIG. 2A is an exemplary diagram for explaining a case when a backlight is turned on with the maximum luminance in the embodiment;

FIG. 2B is an exemplary diagram for explaining another case when the backlight is turned on with the maximum luminance in the embodiment;

FIG. 3A is an exemplary diagram for explaining a case when the backlight is turned on with ⅔ of the maximum luminance in the embodiment; and

FIG. 3B is an exemplary diagram for explaining another case when the backlight is turned on with ⅔ of the maximum luminance in the embodiment.

### DETAILED DESCRIPTION

Various embodiments according to the invention will be described hereinafter with reference to the accompanying drawings. In general, according to one embodiment of the invention, An image processor, comprises: a luminance calculator configured to calculate a luminance of an illumination light based on an image signal, the illumination light illuminating a display screen displaying the image signal; a gradation corrector configured to correct a first gradation of the image signal to a second gradation, based on the luminance; a parameter determining module configured to determine a parameter of gradation smoothing process to be performed on an amplitude of the image signal based on the luminance; and a processing module configured to perform the gradation smoothing process on the image signal with the second gradation, by using the parameter.

According to another embodiment of the invention, an image processing method, comprises: calculating a luminance of an illumination light based on an image signal, the illumination light illuminating a display screen displaying the image signal; correcting a first gradation of the image signal to a second gradation, based on the luminance; determining a parameter of gradation smoothing process to be performed on an amplitude of the image signal based on the luminance; and performing the gradation smoothing process on the image signal with the second gradation, by using the parameter.

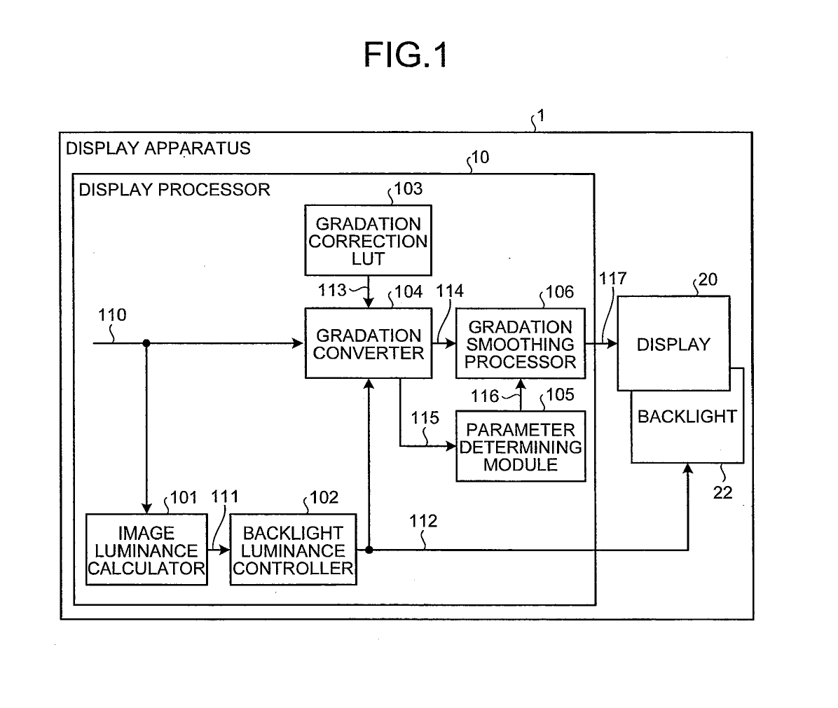

FIG. 1 is a block diagram illustrating a configuration of a display apparatus 1 according to an embodiment of the invention. The display apparatus 1 comprises a display processor 10, a display 20, and a backlight 22 as an illuminator. The display 20 is a non-light-emitting display device such as a liquid crystal display (LCD) device, and displays an image when the backlight 22 illuminates the display 20. The backlight 22 is, for example, a light emitting diode (LED). The backlight 22 is divided into a plurality of areas, and the luminance of the backlight 22 is controlled for each areas.

The display processor 10 processes an RGB video input signals 110, and outputs it to the display 20. Further, the image processor 10 calculates the luminance of the backlight 22 based on the input RGB video input signals 110, and controls the backlight 22 so that the backlight 22 emits illumination light with the calculated luminance. In particular, the image processor 10 processes the RGB video input signals 110 by each pixel, based on the RGB video input signal of each area of the backlight 22, and controls the luminance of the backlight 22 by each area.

The image processor 10 comprises an image luminance calculator 101, a backlight luminance controller 102, a gradation correction look up table (LUT) 103, a gradation corrector 104, a parameter determining module 105, and a gradation smoothing processor 106.

The image luminance calculator 101 divides the RGB video input signals 110 into blocks corresponding to the number of areas the backlight 22 is divided into. Then, the image luminance calculator 101 calculates a luminance value of the backlight 22 for each block based on the RGB video input signal 110 of each block. In particular, when the luminance of the RGB video input signals 110 is low, the image luminance calculator 101 performs the calculation so that low backlight luminance value is calculated. Then, the image luminance calculator 101 outputs the luminance signal 111, which is the result of the calculation, to the backlight luminance controller 102.

The backlight luminance controller 102 generates a luminance control signals 112 for controlling the backlight luminance of each block based on the luminance signals 111, and outputs it to the gradation corrector 104 and the backlight 22.

The gradation corrector 104 acquires profile information 113 of the backlight 22 stored in the LUT 103, and calculates the luminance value of the backlight 22 for each pixel based on the profile information 113. Further, the gradation corrector 104 corrects the gradation of the RGB video input signals 110 based on the calculated luminance value. Here, the gradation of the RGB video input signals 110 is corrected to a value so that an apparent brightness of the corrected RGB video input signals 110 displayed on the display 20 becomes equal to brightness of the RGB video input signals 110. The gradation corrector 104 outputs gradation corrected video signals 114 obtained by the gradation correction to the gradation smoothing processor 106.

When the low backlight luminance value is calculated by the image luminance calculator 101, the gradation corrector 104 expands the dynamic range of the RGB video input signals 110 to obtain the gradation corrected video signals 114. At this time, quantization noise is also amplified in response to the expansion of the dynamic range. In other words, the gradation corrected video signals 114 input to the gradation smoothing processor 106 contains the amplified noise. Therefore, the gradation corrector 104 specifies the amount of amplification of the quantization noise, and outputs the specified amount to the parameter determining module 105 as an amplified amount 115.

The parameter determining module 105 preliminarily stores therein a reference value of a parameter used by the gradation smoothing processor 106 during the gradation smoothing process. The parameter determining module 105 determines a parameter that is actually used during the gradation smoothing process, based on the reference value and the amplified amount 115 obtained from the gradation corrector 104. In particular, the parameter determining module 105 corrects the reference value based on the amplified amount 115, and determines the corrected value as the parameter. For example, when the amplified amount 115 is 1.5 times the original RGB video input signals 110, the reference value is multiplied by 1.5. Then, the parameter determining module 105 outputs the corrected parameter value to the gradation smoothing processor 106 as the correction parameter 116.

The gradation smoothing processor 106 performs gradation smoothing process on the gradation corrected video signals 114 by using the corrected parameter 116 obtained from the parameter determining module 105. The corrected parameter 116 is a value corrected in accordance with the amount of the amplified quantization noise. Therefore, even when the noise is amplified, the amplified noise can appropriately be smoothed out by the gradation smoothing process. The gradation smoothing processor 106 outputs RGB image output signals 117 obtained by the gradation smoothing process to the display 20.

As described above, the display apparatus 1 according to the embodiment can change the degree of smoothing out the quantization noise in accordance with the backlight luminance value. Accordingly, even when the backlight luminance is changed, the quantization noise can appropriately be reduced, while the dynamic range is expanded.

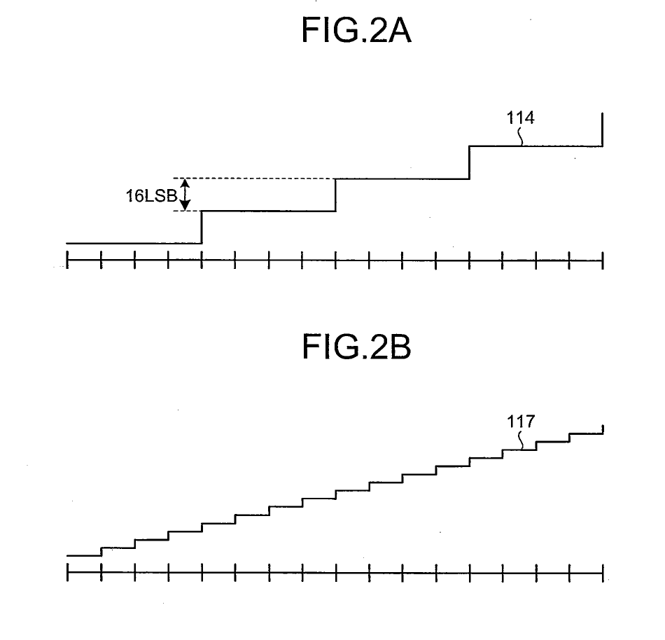

FIGS. 2A and 2B are diagrams for explaining a case when the backlight 22 is turned on with the maximum luminance. The horizontal axis in FIGS. 2A and 2B is a time axis on which sampling clock intervals are indicated. In the case considered in FIGS. 2A and 2B, the gradation corrected video signals 114 contains the quantization noise (quantization error) of 16 last significant bits (LSB). Further, in the case considered in FIGS. 2A and 2B, the parameter determining module 105 stores therein a value of 16, which is a parameter for smoothing out the quantization error 16 LSB. In this case, the amplified amount 115 is multiple of 1, and the parameter determining module 105 outputs the stored parameter to the gradation smoothing processor 106 as the correction parameter 116.

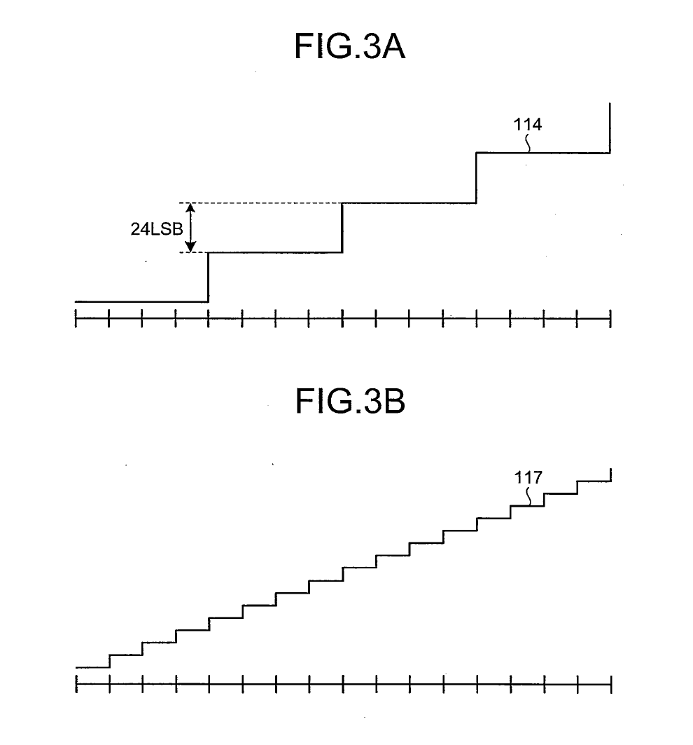

FIGS. 3A and 3B are diagrams for explaining a case when the backlight 22 is turned on with brightness of ⅔ of the maximum luminance. In this case, the gradation corrector 104 multiplies the RGB video input signals 110 by gain of 1.5 times. Accordingly, an amplitude and a quantization error of the signal itself is 1.5 times increased. Hence, the quantization error is changed from 16 LSB to 24 LSB. The gradation corrector 104 outputs the gradation corrected video signals 114 containing the quantization noise of 24 LSB to the gradation smoothing processor 106. Further, the gradation corrector 104 outputs the amplified amount 115 of 1.5 times to the parameter determining module 105.

The parameter determining module 105 obtains the amplified amount 115 of 1.5, multiplies the parameter reference value of 16 by 1.5 to obtain the correction parameter 116 of the value of 24, and outputs the correction parameter 116 to the gradation smoothing processor 106. The gradation smoothing processor 106 performs the gradation smoothing process on the gradation corrected video signal 114 by taking the RGB video input signals 110 of up to the value of 24 LSB, which is the correction parameter 116, as the quantization noise. Consequently, as illustrated in FIG. 3B, the RGB image output signals 117 with smooth gradation can be obtained.

When the backlight 22 is turned on with the brightness of ⅔ of the maximum luminance, the dynamic range of the RGB video input signals 110 is expanded. Accordingly, when the gradation smoothing process is performed with the initial value of the parameter of 16, a difference of 24 LBS will not be recognized as the quantization error. Therefore, the difference of 24 LBS is not to be smoothed out. On the other hand, according to the display apparatus 1 of the embodiment, the value that is to be recognized as the quantization error is determined based on the expansion of the dynamic range of the RGB video input signal 110, i.e., the amplification of the quantization noise. Accordingly, an appropriate gradation smoothing process can be performed to obtain excellent output image.

As described above, the display apparatus 1 according to the embodiment can display a smooth video signal with high dynamic range and without causing Mach bands and the like due to the quantization noise. The display apparatus 1 according to the embodiment can appropriately smooth out the quantization error.

In the present embodiment, the video signal is input to the display apparatus 1. However, still image data can be input to the display apparatus 1.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processor, comprising:
a luminance calculator configured to calculate a luminance of an illumination light based on an image signal, the illumination light illuminating a display screen displaying the image signal;
a gradation corrector configured to correct a first gradation of the image signal to a second gradation, based on the luminance;
a parameter determining module configured to determine a parameter of gradation smoothing process to be performed on an amplitude of the image signal based on the luminance; and
a processing module configured to perform the gradation smoothing process on the image signal with the second gradation, by using the parameter.

2. The image processor of claim 1, wherein
the gradation corrector is configured to correct the first gradation of the image signal with smaller luminance to the second gradation with larger dynamic range, and
the parameter determining module is configured to determine the parameter so that a larger amplitude of the image signal is smoothed as the luminance is smaller.

3. The image processor of claim 1, wherein
the gradation corrector is configured to specify an amplified amount of an quantization error due to the gradation conversion from the first gradation to the second gradation, based on the luminance, and
the parameter determining module is configured to determine the parameter based on the amplified amount.

4. The image processor of claim 1, further comprising:
the display screen configured to display the image signal to which the gradation smoothing process is performed; and
an illumination module configured to illuminate the display screen by the illumination light with the luminance.

5. An image processing method, comprising:
calculating a luminance of an illumination light based on an image signal, the illumination light illuminating a display screen displaying the image signal;
correcting a first gradation of the image signal to a second gradation, based on the luminance;
determining a parameter of gradation smoothing process to be performed on an amplitude of the image signal based on the luminance; and
performing the gradation smoothing process on the image signal with the second gradation, by using the parameter.
